(19) United States
(12) Patent Application Publication
(10) Pub. No.: US 2007/0219987 A1
(43) Pub. Date: Sep. 20, 2007

(54) Self Teaching Thesaurus

(75) Inventors: Raymond J. Mueller, Palm Beach Gardens, FL (US); Andrew S. Van Luchene, Santa Fe, NM (US); Dean Alderucci, Westport, CT (US)

Correspondence Address: GONZALES PATENT SERVICES, 4605 CONGRESS AVE. NW, ALBUQUERQUE, NM, 87114, US

(73) Assignee: LEVIATHAN ENTERTAINMENT, LLC, Santa Fe, NM (US)

(21) Appl. No.: 11/697,443

(22) Filed: Apr. 6, 2007

Related U.S. Application Data
(63) Continuation-in-part of application No. 11/668,596, filed on Jan. 30, 2007.
(63) Continuation-in-part of application No. 11/668,586, filed on Jan. 30, 2007.
(63) Continuation-in-part of application No. 11/462,621, filed on Aug. 4, 2006.
(60) Provisional application No. 60/727,191, filed on Oct. 14, 2005.

(51) Int. Cl. G06F 17/30

(52) U.S. Cl. 707/5

(57) ABSTRACT

A database, such as a patent database, including a plurality of electronic documents, such as patents and patent applications, is described. The documents include words, phrases, and/or pictures that have been hyperlinked to advertisements or other documents. Also described are methods of indexing words and phrases in the documents and allowing advertisers, merchants, or other entities to pay for the right to hyperlink selected words, phrases, pictures that appear in the documents in the database to web-based documents of their choosing.

### CROSS REFERENCE TO RELATED APPLICATIONS

The present application is a continuation in part of U.S. patent application Ser. Nos. 11/668,596, “Keyword Advertising in Invention Disclosure Documents” filed Jan. 30, 2007, 11/668,586; “Targeted Advertising Based on Invention Disclosures” filed Jan. 30, 2007; and 11/462,621, “Fee-Based Priority Queuing for Insurance Claim Processing” filed Aug. 4, 2006, which claims the benefit of U.S. Provisional Patent Application No. 60/727,191, filed Oct. 14, 2005, each of which is hereby incorporated by reference.

### BACKGROUND OF THE INVENTION

The internet allows people to access enormous amounts of information in a fast and efficient manner. Frequently, large numbers of related or unrelated documents are maintained in searchable databases, which users can access in order to find information of interest. An example of such a database includes the USPTO Patent and published patent application databases. Databases may be publicly or privately available and may or may not charge a fee for access. As the availability of information over the internet grows, advertisers continue to search for new ways to provide advertising to those consumers who seem more likely to be interested in their products. This decreases advertising costs, allowing merchants to increase revenue and pass savings on to consumers. Accordingly methods and systems to take advantage of the self-selectivity of database users by providing directed advertising to potential consumers based on the items viewed in a database would be advantageous.

### DETAILED DESCRIPTION

According to various embodiments, the present disclosure provides a self teaching thesaurus that is configured to associate words and phrases based on user selection information. According to some embodiments:

Advertisement—includes any communication via any medium to any one or more end users or any person or third party. Advertisements include any communication which may consist of any form or combination of any one or more of the following, including, but not limited to any text, audio, video, icons, graphics, images, etc. Advertisements may include an offer for sale, for profit or not, and may or may not include a discount, for any services, products, financial instruments, e.g., insurance, annuities, securities, e.g., stocks, bonds, options, etc. and/or any other good or service, and/or may provide information about any of the forgoing or anything, such as a request for donations to political or charitable or any other entity or organization. Or, an advertisement might be used or designed to provide information to inform or educate any constituent and/or may include communications in support of any one or more objectives such as public relations, publicity, product placement or introduction, sponsorship, underwriting, public notice or service announcement or any other objective or purpose. The terms Ad, Advertisement, Advertising shall have corollary meaning.

Alert—includes the transfer, delivery or storage of information or otherwise communicating with, by, between or among any two or more of the following, including, but not limited to any real or virtual: a) end user, b) game owners, c) game or other servers, d) player or player characters, e) NPC's, f) exchanges, g) game devices or controllers, h) cell phone or other communications hardware and/or networks, i) databases, j) software applications, k) legal agencies, l) governing bodies, m) software interfaces, n) any person, o) and/or any combination of any of the above, which may be initiated by and/or based upon an alert event or other action.

Alert Event—includes any change in, of or to any condition or state, and includes any action, opposite action, unexpected action, desire for action, or failure to act, and thus Alert Event includes, but is not limited to any one or more of:
1. When or after any one or more variables or data changes or is expected or is about to change within an application, service, API, communications network or one or more databases, or database variables or element, e.g., a balance is reached or exceeded
2. When an end-user acts, e.g., clicks on a word or link, or fails to act as or when expected.
3. An amount of time elapses with or without an action.
4. When or after information is transmitted and/or shared (e.g. via a communications package or other mechanism) between two or more applications, services, servers, financial institutions, or any other entities, e.g., a message sent between two servers to provide information about one or more hyperlinks.

Antonym—is any word or group of words that have the nearly or exactly the opposite meaning of another word or group of words. The opposite of antonym is synonym.

Approval Queue—includes a queue of documents and or prior art associated with those documents that is awaiting an approval mark from an entity such as a patent examiner

Boilerplate—includes any text, word, words, or phrases and/or part or all of a document which may be readily or otherwise reused with little or no modification and/or to serve as the basis of a new phrase or document, which use may save time and effort in the creation of said phrase or document. Boilerplate may include standard documents, terms, conditions, words, phases, etc., that can be incorporated or reused in multiple applications.

Blog—includes a user-generated website or other system where entries may be made in journal or other style and may be displayed in a reverse chronological or other order. Blogs often provide commentary or news on a particular subject, such as food, politics, or local news; some function as more personal online diaries. Blogs may include and/or combine or use text, images, and may include links, including hyperlinks to other blogs, web pages, documents, words, and other media related to its topic or subject matter. The term “blog” is derived from the term “Web log.” “Blog” can also be used as a verb, meaning to maintain or add content to a blog.

Certified Component—includes any piece of software that is a component of a total software solution that has been approved for use by an entity such as the USPTO

Certified Definition—includes the definition of a word or phrase as it relates to a class or subclass of patentable inventions that is approved by an central entity such as the USPTO

Certified Font—includes any font that is approved by a central entity such as the patent office for use in an invention disclosure or figures associated with such a disclosure.

Certified Icon—includes any icon that can be used in a figure to be submitted with a patent application to identify a standard component of invention that is approved for it use by a central entity.

Certified Plug-in—includes any software module that can be inserted into a larger software program and used to perform a sub function of the total function of the total system that is approved by a certification party such as the USPTO

Certified Shape—shall include any visual shape that can be used to identify a component in a patent or other drawing that is approved by a central entity such as the patent office for use in a figure associated with an invention disclosure

Certified Template—shall include a group of certified shapes, certified Icons, and or certified fonts that can be used in a figure associated with an invention disclosure and that is approved by a central entity such as the patent office.

Class—includes a class of patents or other digital documents in an electronic database

Click-through—includes the process of an end user selecting or otherwise activating a hyperlink

Definition—include the dictionary definition of a word that can be modified or enhanced by third parties using a service such as Wikipedia and/or the methods disclosed herein.

Documents—includes any information or collection of information that can be accessed by an end user. Documents include, for example, word documents, words, news paper, magazine and other articles, white papers, blogs, technical manuals, online and other catalogs, web sites, web pages, survey questions and responses, patent applications, including any pending, published and/or issued patent(s), diagrams, figures, IDS, databases of electronic information, images, graphics, software applications, or modules, including graphical user interfaces, software or code, source or object code, forms, such as insurance forms, queues, e.g., a list of patents to be processed, office actions, examiner notes, and other notes, hyperlinks, computer files and other electronic media and/or content and/or data. In certain embodiments, a document includes and may be comprised of, in whole or in part, and/or include one or more words and/or phrases and/or attachments.

Document Map or Map—includes a visual representation of a group of documents or other items or objects, such as patents that shows the relationship of those documents, objects or items to one another. For example, a map might be of a group of documents and their relevancy to each other. Or, a map might include a visual representation.

End User—includes any person or entity, real or virtual that makes use of or otherwise practices any part or all of the disclosed invention and/or any software application or tool disclosed herein or otherwise. End users include, for example, patent applicants, patent examiners, patent attorneys, patent examiner supervisors, document review specialists, diagram or figure design engineers, survey respondents, search tool users, and other persons. In certain embodiments, an end user may be an application, application program interface, reporting or other tool or automated process.

Figure—includes any diagram, drawing, schematic, image, graphic, icon, document, figures, pictures, audio, video or other data, which, in some embodiments, such figure(s) may be attached to or otherwise associated with an invention disclosure, patent application, continuation in part, or other document that further defines, for example, an invention disclosure, patent application, continuation in part and/or other document and/or part, product, service, goods, etc. In some embodiments, a document can be a figure and/or a figure can be a document.

Genetic Algorithm—includes any software application or module that can improve results with use.

Hyperlink—includes a link or action or set of instructions or code, which may be embedded or is otherwise associated with or connected to, for example, an element, word, object, icon, document, figure, map, file attachment, or other displayed area within, for example, a document or webpage, which, when selected, clicked or otherwise activated may cause a computer to perform one or more functions, e.g., display new or additional information and/or redirect an end user to a different area of the same or a new web page and/or website, and/or may cause other actions to be taken, e.g., display a advertisement, solicit and/or capture information about the word, end user, or system that stores the words and/or documents and/or the system that is accessing the word or document, and/or open a form that requires end user input, and/or may display new information that is generally associated with and/or relates to such link. Such new or additional information and/or webpage(s) may or may not be displayed using a separate or new web browser page or popup window or interstitial. Hyperlinks are commonly identified through the use of an underline and/or color coding, e.g., HYPERLINK, but this is not necessarily required or desired. Hyperlinks may be activated by any applicable means, including, but not limited to, left or right clicking on or near the link, placing a pointer on or near the link (briefly, temporarily or not), touching the area, e.g., via use of a touch screen or other pointing mechanism, and/or automatically, e.g., based upon date or time, or other action or inaction of the end user, e.g., failure to respond within a given timeframe may cause execution or delay of execution of one or more computing steps or hyperlink(s). Such links may be associated with other hyperlinks, e.g., hyperlinks within hyperlinks, documents, programs, words, phrases, or other information or actions. For example, if an end user right clicks on a hyperlink, one or more options may appear, permitting the end user some degree of flexibility in the action or actions taken. The terms link and hyperlink shall have corollary meanings.

IDS—includes the definition provided by the USPTO

IDS Report—includes a document that references all prior art material associated with a patent application or invention disclosure

Image—includes figures, pictures, drawings, document images, e.g., document snapshots, etc.

Improvement Module—includes a sub module that is embedded in a total system that is used to improve upon the total system or other sub modules embedded in that system.

Keyword—includes any word or words within a document of interest to a merchant.

Lexicon—includes a group of words with corresponding definitions that is broken into classes and subclasses that are associated with the class and subclass of documents in a database such as the digital database of filed and or issued patents of the USPTO

Mapping—includes the process of associating documents to one another and providing a visual representation of the relationships of those documents.

Merchant—includes any person that desires to sell a good or service or desires to have one or more end users to review, select, or click a hyperlink in a document and/or receive other information and/or perform other tasks and/or receive information associated with one or more keywords selected by such merchant.

Notes—includes any computer file or data or any free form or other text, graphics, figures and/or any files such as any audio, video, e.g., JPEG or MPEG, pictures, e.g., GIF, or other files, such as, PDF, XLS, XML, TXT, DOC, RTF, or any other known files such as those described on the websites: http://filext.com/ and http://www.computeruser.com/resources/dictionary/filetypes.html, which are incorporated herein by reference. Notes may be attached or associated with any one or more of the following, including, any electronic element, word or words, phrase, document, figure, hyperlink, webpage, database, table, file, or any other electronic media. Notes may include any description, hyperlink, figure, document or file associated or attached to any of the forgoing and/or any combination of the forgoing. In certain embodiments, notes may contain or refer or reference other notes, e.g., notes within notes.

Patent Application—includes an invention disclosure that has been filed with a registration entity such as the USPTO

Patent Application Drafting Tool—includes a web based software program that assists in the drafting and filing of patent applications with a registration entity such as the USPTO

Patent Drafting Engine—includes a software module that can partially or completely draft and/or modify an existing draft patent application and/or file those applications with a registration entity such as the USPTO.

Patent Figure—includes any figure or document attached to a patent application

Patent Section—includes any section of a patent application or invention disclosure such as the background, summary, title, abstract and or claims.

Patentability Score—includes a score assigned by one or more people, e.g., an end user, or computer programs to a patent application that relate to its strength of patentability in categories such as novelty, obviousness, and usefulness.

Plug-in—includes any software application or module or one or more computer instructions, which may or may not be in communication with other software applications or modules, and may include any file, image, graphic, icon, audio, video or any other attachment. Plug-ins may be comprised of any one or more set of computer instructions using any computer programming language.

Relevancy—includes how relevant a word, phrase, patent section, patent figure or document is to another word, phrase, patent section, patent figure or document

Rules—includes computer instructions that can provide application direction and/or decision making and includes both inference and reactive rules. Rules may include permissions, limitations, method steps, alert event conditions, alert contents, workflow instructions, security measures, business process management instructions, if/then/else instructions and/or any supporting data, variables, or computing instructions and/or logic.

Rules Based—includes any system or application or module that uses or relies on one or more rules.

Search Relevancy—includes how relevant sections of a document are to a word, phrase, patent section, patent figure, or document are when producing search results for a query. For example, the abstract of a patent document can have higher search relevancy than the background of a patent document when conducting prior art searches using a prior art search software tool.

Search Weight—shall mean the score that one section of a document has to other sections of a document when conducting searches against a database of documents in which that document is included.

Subclass—includes a subclass of patent documents as defined by the USPTO. Subclass can also include any sub classification of a database of electronic documents.

Synonym—is any word or group of words that have the same or similar meaning of another word or group of words and/or that may be interchangeable. The opposite of synonym is antonym.

Thesaurus—includes an electronic database of words that have been mapped to indicate similarities in word definitions. The thesaurus may be broken into classes and subclasses that relate to the classes and subclasses of documents stored in an electronic database and/or accessed via such database

Virtual—includes anything that is not real, in whole or in part, and/or anything real, in whole or in part; which may be simulated, represented, presented or depicted in a virtual environment, video game or displayed on a screen.

Virtual Environment—any technology that permits one or more end users to interact with a real, imaginary or virtual computer simulated environment.

Virtual World—includes a world created in an online game such as World of Warcraft, or a virtual community such as Second Life, Eve or There.com

Video Game—shall mean any massive multi online player game such as World of Warcraft and any virtual world such as Second Life

Web page—includes any resource, form, or any information that is accessible via the Internet and that is suitable or exists on the world wide web. A web page usually includes information in any applicable format, e.g., HTML or XHTML. Web pages may include hyperlinks or provide other means of navigation to other web pages. Web pages may be accessed by any applicable means, including, but not limited to: any computing or internet enabled devices, e.g., personal computers, laptops, PDAs, cell phones, video game controllers, or any other communications device, which may be local or remote to the computer or server where such web page(s) may exist or reside.

Word—includes one or more groups of letters including titles, indices, text, headings, descriptions, diagrams, etc., and documents (in whole or in part), phrases (i.e., groups of two or more words), synonyms, antonyms, icons, graphics, drawings, schematics, blueprints, pictures, audio and/or video, and/or any combination of the forgoing, The words “Word” and “Words” shall have corollary meanings.

As stated above, according to various embodiments, the present disclosure provides a self teaching thesaurus that is configured to associate words and phrases based on user selection information.

The user selection information may be obtained from a system configured to allow merchants or other entities to purchase the right to hyperlink one or more keyword in a database with a destination document. An exemplary tool for preparing submitting documents via the Internet is disclosed for example, in U.S. patent application Ser. No. 11/627,263 “Automated Web-Based Application Preparation and Submission” filed Jan. 25, 2007, which is incorporated herein by reference.

Briefly, according to one embodiment of the '263 application, merchants (or other entities) acquire rights to hyperlink one or multiple keywords to one or more destination documents. The destination documents may take the form, for example, of merchant advertisements, websites or one or more applications, modules or other information and/or data. Furthermore, merchants may modify their rights by specifying particular types of documents, the desired position of the keywords in the documents, or other factors.

According to one embodiment of the present disclosure, whenever two or more keywords are linked to the same destination document, the system is configured to automatically associate the two words as being related. For example, if a merchant that provides fishing gear rents the keywords “fishing pole” and “fishing rod” and links them to the same advertisement for fishing gear, the thesaurus system of the present disclosure learns that these two keywords are related. According to one embodiment, the system may enter the words into a database constructed for such purpose and indicate in the database that the words may be related.

As more end users, or merchants acquire rights in or to words and/or associate hyperlinks, e.g., advertisements, with such words and/or phrases, the system can expand and improve upon the database entries and identify more and more words as being generally or otherwise similar to other words similarly acquired or linked. Over time, the system can expand its database of entries to build a large repository of synonyms and/or antonyms.

The association between two or more keywords may be assigned a relevancy rating, indicating the degree of relationship—e.g. according to some systems of assigning relevancy, words that have a 100% relevancy rating are words that will always be considered exact synonyms. For example, the term “rod” and the term “pole” may have a lower relevancy, e.g., 70%, whereas the words “fishing rod” and “fishing pole” may be assigned a higher relevancy percentage, e.g., 90%. Such percentages or relevancy scores may be determined by any applicable means, including, but not limited to, based upon any one or more factors such as, the frequency a given merchant acquires rights in or to two or more words, in one or more databases and/or one or more documents and/or associates such words to the same or similar hyperlink and/or website and/or other document, web page, information, product, service, advertisement, message, note, application, module or plug-in, and/or the frequency one or more of the merchant's competitors acquire rights in and to the same or similar words and/or known or determined synonyms and/or link such words to similar products, goods, and services, and/or feedback provided by end users and/or merchants or any third party, for example, in response to one or more questions, e.g., survey questions, to determine such relevancy, or any combination of the forgoing. Acquisition of such survey responses may be made by any applicable means. In certain embodiments, relevancy scores may be determined, in whole or in part, through the use of manual and/or automated means. In addition to the novel relevancy ranking methods disclosed herein, other methods to determine relevancy between and among documents and/or websites are well known within the prior art, including, for example, the methods discussed in the book entitled “Text Databases and Document Management: Theory and Practice, by Amita Goyal Chin. Furthermore, methods to provide for such survey questions and gathering of data are disclosed by applicants in U.S. Patent Application Nos. 60/774,177, entitled “Survey Based Qualification of Keyword Searches,” 11/278,123, also entitled “Survey Based Qualification of Keyword Searches” 11/562,738 “Survey Based Qualification of Keyword Searches” and 11/608,150, entitled “Map and Inventory Based On-Line Purchases” which applications are incorporated herein by this reference.

Methods to create web pages, hyperlinks and hypertext are well known in the prior art and any person with ordinary skill in the art can design and create such hyperlinks. Methods to design and create hypertext and/or hyperlinks are discussed and disclosed by the authors of the following reference and other materials, including, for example: “Intelligent Hypertext: Advanced Techniques for the World Wide Web (Lecture Notes in Computer Science), by Charles Nicholas and James Mayfield,” “Information Architecture for the World Wide Web: Designing Large-Scale Web Sites [ILLUSTRATED], by Louis Rosenfeld (Author), Peter Morville,” Creating Web Pages with HTML Simplified, by Sherry Willard Kinkoph (Author),” “Master Visually Web Design (With CD-ROM) by Carrie F. Gatlin and Michael S. Toot,” and “Creating Internet Intelligence: Wild Computing, Distributed Digital Consciousness, and the Emerging Global Brain (IFSR International Series on Systems Science and Engineering), by Ben Goertzel.” Each of which is hereby incorporated by reference.

According to some embodiments, the thesaurus may be presented or is otherwise made accessible to end users who (1) search the document database or (2) are preparing documents to include in the document database, or (3) desire to acquire rights in and/to the document and/or in or to one or more words and/or to insert or associate one on more hyperlinks with such one or more words and their website and/or other information or processes associated with such merchant and/or that is otherwise of interest or of benefit to such merchant.

Furthermore, the thesaurus may also be presented to merchants who use only a subset of words that the thesaurus has identified as being related. In this way, merchants may opt to associate hyperlinks with more words.

As a further embodiment, merchants may associate advertisements with such one or more words. For example, a pop-up ad, roll over ad, or other advertisement may appear whenever an end user accesses a page in the document that contains a selected keyword.

In certain embodiments, the thesaurus may be initially and/or subsequently and/or periodically populated using existing or traditional resources such as a published thesaurus. An example of a commercially available thesaurus is Roget's Thesaurus. Use of preexisting resources can speed the initial creation and population of the database, as well as increase or aid in establishing accurate associations. For example, when initially establishing a synonym database, the system may associate words that are identified as synonyms in a published thesaurus with a high degree of certainty, i.e., by assigning a 100% association or relevancy and/or by using some other ratio.

The system may or may not permit a modification to a relevancy assignment over time. For example, the word “book” maybe entered as a synonym in an existing thesaurus of the words “tome” “manuscript” and “volume,” etc. While the first two synonyms, i.e., tome and manuscript, may generally have a high relevancy to the word book, the word volume, may be assigned an initial or subsequently higher or lower relevancy. Such initial or subsequent assignment of relevancy may be made by any applicable means, including, for example, the existence of alternative initial or subsequent associations between other words, e.g., the word “volume” may also be associated with the words: “quantity” “amount” “degree” “size” “level” “number” and/or “sounds.” Based upon such degree and extent of other such synonyms and/or antonyms, the system may assign initial relevancy percentages based upon some non-equal percentage. In certain embodiments, such initial percentages may be retained on a temporary or permanent basis. In the cases where such initial percentages are retained permanently, the system may associate additional relevancy percentages with such word or words. In such fashion, the system is able to learn and determine or improve the accuracy of such percentages over time.

In contrast to other systems that identify synonymous and antonymous relationships based on “dictionary definitions,” the current system observes actions of users and identifies relationships based on behavioral commonalities rather than simply dictionary definitions. Accordingly, the disclosed system determines relationships between and among words that are based on real world use and input and that may not have obvious or other immediately apparent relationships. For example, in certain embodiments, the word “reel” may be associated with the word “pole” although one is not generally considered a synonym or antonym of the other. However, the system may determine that one or more users interested in and/or that review information or select or otherwise click on hyperlinks associated with the word “pole,” may also be generally interested or prompted to action by the word “reel.”

In certain embodiments, the system may assign multiple relevancy percentages, which may be determined by any applicable means and may include numerous such relevancy percentages. The system may track the relevancy of words within a document, multiple documents, classes, sub-classes or categories of documents, classes of trade, and/or organized by any other applicable means. For example, the relevancy of the words volume and dimensions in the context of or used within a book regarding stereo systems may be low, while, the same words, i.e., volume and dimensions may carry a higher relevancy when used in the context of a book on geometry or shipping containers. Relevancy percentages may be initially established and/or modified over time. The number tracked may be fixed, e.g., two (i.e., one for the initial setting and one for variable or modifiable settings) or unlimited, e.g., the number of relevancy scores may be determined by any applicable means, including, for example, the number of different merchants vying for the same or similar words but perhaps belonging to entirely different classes of trade.

In addition to or as an alternative to generating a thesaurus of keywords, the system can also use the merchant selection of documents and keywords to map documents together as being similar or dissimilar. The system creates a new classification system of the documents based on which documents certain merchants purchase keywords and/or based upon actual end user usage over time.

According to yet another embodiment, the thesaurus can also be added to or otherwise revised by other end users or merchants or other third parties who can type additional text into a notes system and/or provide feedback via usage of a survey application. Such notes, survey responses, feedback and/or revisions or access may require such end users, merchants or other third parties to obtain permission or other authorizations.

Such feedback, notes, modifications and/or survey question responses may or may not require the end user to submit a form of identification, e.g., user name, actual name, driver's license, passport number, etc. Exemplary methods to provide for survey questions and gathering of data are disclosed by applicants in U.S. Patent Application No. 60/774,177, entitled “Survey Based Qualification of Keyword Searches,” Ser. No. 11/278,123, also entitled “Survey Based Qualification of Keyword Searches” Ser. No. 11/562,738 “Survey Based Qualification of Keyword Searches” and Ser. No. 11/608,150, entitled “Map and Inventory Based On-Line Purchases” which applications are incorporated herein by this reference. Exemplary methods to provide attachment of notes into documents and/or associate notes with documents, or words, or other data are disclosed in U.S. patent application Ser. Nos. 11/690,095 “Facilitating Certified Prior Art Note Taking and Method for Using Same,” filed Mar. 22, 2007; ______ (Attorney docket No. 3307102) entitled “Note Overlay System,” filed Apr. 6, 2007; and ______ (Attorney docket No. 3307103) entitled “Document Examiner Comment System,” filed Apr. 6, 2007; each of which is incorporated herein by reference.

According to yet another embodiment, search engines can use the thesaurus to link additional documents to the original documents. End users can search these from a GUI provided with the display of the original document and/or that provided by such search engine(s), e.g., Google. Additional search engine improvements may be incorporated into new or existing search engines to permit further end user control or added benefits. Exemplary methods for providing patent and prior art searches are disclosed in U.S. patent application Ser. Nos. 11/671,380, “Automated Patent Searches” filed Feb. 5, 2007; 11/693,555 “Providing Certified Patent Searches Conducted by Third Party Researchers” filed Mar. 29, 2007; and ______ (Attorney docket No. 3304103) entitled “Enhanced Patent Prior Art Search Engine,” filed Apr. 6, 2007; each of which is hereby incorporated by reference.

According to yet another embodiment, a report of like documents can be prepared for an end user who is using the thesaurus to draft a document that can be contributed to the database of documents. This report can be edited and submitted to the database provider along with the drafted document. In certain embodiments, end users and/or merchants can provide feedback and/or include notes using methods hereinabove described. Such notes and/or feedback can be used to affect relevancy scores, update reports, and/or assist end users, merchants and/or third parties to determine if certain keywords or documents are of general or specific interest, and/or to provide information to enable improvements to the system's relevancy calculation methods, for example, such feedback and/or survey responses may be used in whole or in part by any applicable means, including, for example, a learning system, e.g., a neural net and/or genetic algorithm, etc. Using such learning systems or reporting, the system may improve it's methods for making such relevancy scores and/or reports used for such analysis or calculations, which calculations may be based, in whole or in part on any known statistical calculation method, e.g., weighted averaging, and/or any such learning systems.

Use and applications of rules based, expert systems and/or genetic algorithms are well known in the prior art and may be implemented using any applicable means. For example, methods to develop rules, expert systems and/or genetic algorithms are discussed and disclosed in various issued and pending patents and reference and other materials, including the following books entitled: “Genetic Algorithms in Search, Optimization, and Machine Learning”, by David E. Goldberg, and “An Introduction to Genetic Algorithms,” by Melanie Mitchell, and “Expert Systems: Design and Development,” by John Durkin,” and “Logical Foundations for Rule-Based Systems (Studies in Computational Intelligence),” by Antoni Ligeza, each and all of which are incorporated herein by reference.

According to yet another embodiment, the advertisements, e.g., the words and/or notes and/or hyperlinks, that merchants type and link to keywords may also used to build the thesaurus and lexicon and/or may be used to affect one or more relevancy scores.

In certain embodiments, before displaying an advertisement and/or before presenting a list of words and/or documents, e.g., from a lexicon of words, it may be desirable to ascertain certain additional information about such advertisement and/or request for information. In such cases, the system may determine that it is necessary, desirable or generally useful to present one or more survey questions to aid in determining which words, documents, or other information should be presented, e.g., to help determine which advertisement might yield generally better results, and/or which word or synonym is generally more relevant given the information known about the end user and/or collected by using and/or displaying and/or gathering results from one or more such survey questions. For example, when an end user enters the word “case” into a search tool designed to retrieve a definition of such word or words, the system might ask the end user the following question or questions: e.g., are you an attorney, are you interested in travel, or are you seeking legal advice. Based upon the end user's response, e.g., if the end user responded in the affirmative to the last question, the system might either provide a definition of case to include legal cases, and/or the system may also provide an advertisement for one or more attorneys seeking clients. Based upon the response to one or more questions, the system may present additional qualifying questions, i.e., additional questions to further narrow the search results and or the sort display results. Exemplary methods to provide for such survey questions in response to an end users search query are provided by applicant's patent application were incorporated by reference above.

In the event that one or more relevancy scores change over time, such changes may affect the fee paid by one or more merchants. For example, if a given word's relevancy or usefulness to a given merchant increases over time, for example, because such word's hyperlink is used more frequently or is proven to be successful in driving business to a given merchant, then such word's relevancy score may be increased and, one or more fees charged to such merchant(s) may be increased therefore.

In certain embodiments, when any relevancy score is changed and/or a note is attached or changed, and/or a new synonym or antonym is added or updated within the thesaurus and/or a new merchant offers to pay a fee or a higher fee than the existing fee and/or one or more merchant's opt to remove a link and/or add a link or hyperlink to or otherwise associate with one or more words, and/or any other change within the disclosed system, its database, rules, scores, or any other action or inaction is taken or fails to occur, the system disclosed may send one or more notices of any such addition or change to any affected or interested parties, which may include end users, merchants or any person or third party. Such notice may be provided by any applicable means. For example, an end user or merchant may be alerted that a change has occurred or has been submitted to one or more words in the thesaurus or lexicon. Such end user or merchant may be alerted via any applicable means, for example, via email message or popup instant message. Exemplary methods to determine alert events and/or to send alerts are disclosed for example, in U.S. patent application Ser. No. 11/676,848 “Virtual Environment with Alerts” filed Feb. 20, 2007 which is incorporated herein by reference.

In certain embodiments, such definitions may be submitted and/or attached and/or mapped by using notes or hyperlinks. Exemplary methods to provide attachment of notes into documents and/or associate notes with documents, or words, or other data are disclosed in U.S. patent application Ser. Nos. 11/690,095 “Facilitating Certified Prior Art Note Taking and Method for Using Same,” filed Mar. 22, 2007; ______ (Attorney docket No. 3307102) entitled “Note Overlay System,” filed Apr. 6, 2007; and ______ (Attorney docket No. 3307103) entitled “Document Examiner Comment System,” filed Apr. 6, 2007; each of which is incorporated herein by reference.

In certain embodiments, the disclosed invention may be practiced in the real or virtual world. For example, a video game may one or more databases of words, e.g., online virtual books. Video games may also provide a database of virtual patents and/or provide for registration of intellectual property, such as patents and/or copyrights.

Exemplary methods and systems for providing protection of intellectual property in a virtual environment are disclosed, for example, in U.S. patent application Ser. Nos. 11/428,263, “Video Game Environment” filed Jun. 30, 2006; 11/620,563 “Copyright of Digital Works in a Virtual Environment,” filed Jan. 5, 2007; 11/689,977, “Digital Rights Management in a Virtual Environment,” filed Mar. 22, 2007; 11/671,373 “Video Game with Control of Quantities of Raw Materials” filed Feb. 5, 2007; 11/680,960 “System for the Creation and Registration of Ideas and Concepts in a Virtual Environment,” filed Mar. 1, 2007; each of which is incorporated herein by reference.

Accordingly, the disclosed invention may be applied to any virtual environment, world or video game(s) or any combination of the forgoing. For example, words and their synonyms and/or hyperlinks to such words or synonyms, such as those disclosed herein may be created, used and/or delivered in the virtual world. Notes, synonyms and/or hyperlinks may be used to provide game owners and or game players or player characters with information, links or advertisements about any virtual or real object, business, transaction, or virtually anything, real or virtual. For example, notes could be used to solicit customers or to provide an offer for the sale of any good or services, including real or virtual goods and services.

Such sale of goods or services and/or the desire of end users and/or merchants to enter into an agreement for the delivery of such goods and services may also require the creation of formal agreements between or among real or virtual end users, merchants, players, or other third parties, real or virtual. In such cases, methods to ensure that agreements are enforceable and that advertising fees are collected in such virtual environments are desirable.

Exemplary methods for providing such contract enforcement and collection of fees are disclosed, for example, in U.S. patent application Ser. Nos. 11/279,991 “Securing Virtual Contracts with Credit,” filed Apr. 17, 2006; 11/624,662 “Securing Contracts in a Virtual World,” filed Jan. 18, 2007; 11/559,158 “Financing Options in a Virtual World” filed Nov. 13, 2006; 11/620,542 “Satisfaction of Financial Obligations in a Virtual Environment Via Virtual and Real World Currency,” filed Jan. 5, 2007; 11/421,025 “Financial Institutions and Instruments in a Virtual Environment,” filed May 30, 2006, and 11/380,489 “Multiple Purchase Options for Virtual Purchases,” filed Apr. 27, 2006; each of which are hereby incorporated herein by reference.

In other embodiments, notes may be used to describe a product, good or service required by one end user, or player or player character and/or to be provided by another end user, merchant, player or player character. Notes may also be used to provide feedback regarding game play, enjoyment, features, desired features, discovered errors, and/or any other form of communication and/or ranking information. End users, merchants and/or players or player characters or other third parties may also desire to use the thesaurus for creating or modifying or use within notes and/or in creating new or modifying existing documents, and/or for creating virtual reports and/or hyperlinks or advertisements, which hyperlinks and/or advertisements may only be used within the virtual world or video game and/or may provide hyperlinks to resources, e.g., web pages outside the video game or virtual world, and/or advertisements may be delivered in the virtual world or video game that may be associated with virtual or real goods and services.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the gaming environment described herein.

Accordingly, the presently described system may comprise a plurality of various hardware and/or software components such as those described below. It will be appreciated that for ease of description, the variously described hardware and software components are described and named according to various functions that it is contemplated may be performed by one or more software or hardware components within the system. However, it will be understood that the system may incorporate any number of programs configured to perform any number of functions including, but in no way limited to those described below. Furthermore, it should be understood that while, for ease of description, multiple programs and multiple databases are described, the various functions and/or databases may, in fact, be part of a single program or multiple programs running in one or more locations.

| Exemplary programs include: | |
|---|---|
| 1. | Thesaurus Generation |
| 2. | Display Program |
| 3. | Search Program |
| 4. | Billing Program |
| 5. | Certification Program |
| 6. | Note Program |
| Exemplary database architectures include: | |
| Word Database | |
| 1. | Word ID |

| | |
|---|---|
| a. | Word Count ID |
| b. | Word |
| c. | Primary Definition |
| d. | Hyperlinks 1-N (e.g., sources/locations of use) |
| e. | Alternative Definitions 1-N |

| | |
|---|---|
| 1. | Definition |
| 2. | Supplied By - ID |
| 3. | Hyperlinks 1-N |

| | |
|---|---|
| f. | Synonym ID - 1-N |

| | |
|---|---|
| 1. | Synonym |
| 2. | Word ID |
| 3. | Relevancy Scores 1-N |
| 4. | Primary Score % |
| 5. | Alternative Score %'s 1-N |

| | |
|---|---|
| g. | Antonym ID - 1-N |

| | |
|---|---|
| 1. | Antonym |
| 2. | Word ID |
| 3. | Relevancy Scores 1-N |
| 4. | Primary Score % |
| 5. | Alternative Score %'s 1-N |

| | |
|---|---|
| h. | Notes 1-N |

| | |
|---|---|
| 1. | Note ID |
| 2. | Note Short Description |
| 3. | Note Long Description |
| 4. | Narrative Text |
| 5. | Attachment Hyperlinks 1-N |
| 6. | Where Used Hyperlinks 1-N |

| | |
|---|---|
| i. | Figure IDs 1-N |
| j. | Change Tracking ID 1-N |

| Change Tracking Database | |
|---|---|
| 1. | Change Tracking ID |
| 2. | Word ID |
| 3. | Change Type (e.g., Add, change, delete) |
| 4. | Change Description |
| 5. | Date/Time |
| 6. | User ID |
| 7. | Before Image |
| 8. | After Image |
| 9. | Relevancy or score |
| 10. | Notes 1-N |
| Figure Database | |
| 1. | Figure ID |
| 2. | Figure Description |
| 3. | Figure or Attachment |
| 4. | Submitted By ID |
| 5. | Source ID |
| 6. | Editor Application ID |
| 7. | Document/Patent Application Where Used ID 1-N |

| | |
|---|---|
| a. | Hyperlinks 1-N |

| 8. | Notes 1-N |
|---|---|
| Document Database | |
| 1. | Document ID |

| | |
|---|---|
| a. | Document Description |
| b. | Document Owner ID |
| c. | Hyperlinks (e.g., document locations) 1-N |
| d. | Class 1-N |
| e. | Subclass 1-N |
| f. | Type 1-N |
| g. | Subtype 1-N |
| h. | Date/Time Stamps |

| | |
|---|---|
| 1. | Submitted/Found/Indexed On |
| 2. | Submitted/Found/Indexed By ID or Hyperlink |
| 3. | Revised on 1-N |
| 4. | Revised By 1-N |
| 5. | Before Image 1-N |
| 6. | After Image 1-N |

| 2. | Notes 1-N |
|---|---|
| Advertiser or Notes Owner Database | |
| 1. | Advertiser/Owner ID |
| 2. | Advertiser/Owner Name |
| 3. | Classes of Trade 1-N |
| 4. | Advertiser/Owner Financial Information |

| | |
|---|---|
| a. | Billing Method ID |
| b. | Credit Card Information |

| | |
|---|---|
| 1. | Preferred Card Number |
| 2. | Preferred Card Holder |
| 3. | Preferred Card Type |
| 4. | Name |
| 5. | Expiration Date |
| 6. | Security Code |

| | |
|---|---|
| c. | Additional Cards 1-N |

| | |
|---|---|
| 1. | Card Number |
| 2. | Card Holder (e.g., Bank Name) |
| 3. | Card Type (e.g., Visa) |
| 4. | Name |
| 5. | Expiration Date |
| 6. | Security Code |

| | |
|---|---|
| 5. | Advertiser/Note Owner Mailing Address |
| 6. | Advertiser/Note Owner Rules Database |

| | |
|---|---|
| a. | Rule ID 1-N |

| | |
|---|---|
| 1. | Word(s)/Documents Applied To 1-N |

| | |
|---|---|
| a. | Rule Description |
| b. | Rules 1-N |
| c. | Billing Terms and Conditions ID 1-N |

| | |
|---|---|
| 7. | Advertiser/Note Owner Attorney of Record |

| | |
|---|---|
| a. | Attorney ID 1-N |

| 8. | Advertiser/Note Owner Qualifications 1-N |
|---|---|
| 9. | Notes 1-N |
| Advertiser/Note Owner Qualifications Database | |
| 1. | Qualification ID |
| 2. | Description |
| 3. | Qualification Type |
| 4. | Years Experience |
| 5. | Fields of Use Applicable 1-N |
| 6. | Notes 1-N |
| Attorney Database | |
| 1. | Attorney ID |
| 2. | Name |
| 3. | Address |
| 4. | Description |
| 5. | Billing Terms and Conditions Database |
| 6. | Billing Method ID |
| 7. | Billing Type |
| 8. | Description |
| 9. | Billing Frequency |
| 10. | Due by # days |
| 11. | Late by # days |
| 12. | Interest Rate Fixed |
| 13. | Interest Rate Variable |
| 14. | Interest Accrues after days |
| 15. | Notes 1-N |
| Accounts Receivable Database | |
| 1. | Advertiser/Note Owner ID |
| | Total Amount Owed |

| | |
|---|---|
| a. | Transaction Detail Records 1-N |

| | |
|---|---|
| 1. | Date of Transaction |
| 2. | Type |
| 3. | Advertisement ID |
| 4. | Word ID |
| 5. | Hyperlinks 1-N |
| 6. | Amount per impression or click through |

| Search Database | |
|---|---|
| 1. | Document ID |
| 2. | Document Location/Hyperlink |
| 3. | Notes 1-N |
| Transaction Database | |
| 1. | Transaction ID |
| 2. | Description |
| 3. | Date/Time |
| 4. | Type |
| 5. | Advertiser/Note Owner ID |
| 6. | Advertiser/Note Owner Rules Used 1-N |
| 7. | Billing T&C's 1-N |
| 8. | Billing Method ID |
| 9. | Transaction Amount |
| 10. | Results 1-N |

| | |
|---|---|
| a. | Note Added, Changed, Deleted, and/or Accessed |
| b. | Hyperlink Clicked |
| c. | Sub-Hyperlinks Clicked 1-N |

| | |
|---|---|
| 1. | Advertisement/Note and/or Webpage) Displayed 1-N |
| 2. | Click Through y/n |
| 3. | Duration of view |
| 4. | Conversion y/n |
| 5. | Conversion dollar amount |

| 11. | Notes 1-N |
|---|---|
| Advertisement Database | |
| 1. | Advertisement ID |
| 2. | Advertiser ID |
| 3. | Description |
| 4. | Words 1-N |
| 5. | Documents 1-N |
| 6. | Hyperlinks 1-N |
| 7. | Advertising Content File 1-N |
| 8. | Notes ID 1-N |
| 9. | Start/Stop Dates/Times |
| Document Class Database | |
| 1. | Class ID |
| 2. | Description |
| 3. | Notes 1-N |
| Documents Sub Class Database | |
| 1. | Subclass ID |
| 2. | Description |
| 3. | Notes 1-N |
| Document Type Database | |
| 1. | Type ID |
| 2. | Description |
| 3. | Notes 1-N |
| Document Sub Type Database | |
| 1. | Subtype ID |
| 2. | Description |
| 3. | Notes 1-N |
| Group Database | |
| 1. | Group ID |
| 2. | Description |
| 3. | Notes 1-N |
| Advertisement Type Database | |
| 1. | Type ID |
| 2. | Description |
| 3. | Notes 1-N |
| Word Count Database | |
| 1. | Word ID |
| 2. | Number of Occurrences |
| 3. | Hyperlinks 1-N |
| 4. | Notes 1-N |
| Survey Database | |
| 1. | Survey ID |
| 2. | Survey Description |
| 3. | Advertiser ID |
| 4. | Survey Question ID 1-N |

| | |
|---|---|
| a. | Question |
| b. | Answer Option 1-N |

| 5. | Notes 1-N |
|---|---|
| Results Database | |
| 1. | Result ID |
| 2. | End User ID |
| 3. | Survey Questions 1-N |
| 4. | Survey Answers 1-N |
| 5. | Date/Time Stamp |
| 6. | Narrative or Text Responses 1-N |
| 7. | Notes 1-N |
| Rules Database | |
| 1. | Rule ID |
| 2. | Rule Description |
| 3. | Rules 1-N |
| 4. | Notes 1-N |
| Search and Survey Database | |
| Word Descriptor Database | |
| Notes Database | |
| 1. | Note ID |

| | |
|---|---|
| a. | Hyperlinks 1-N |
| b. | Note Description Short |
| c. | Note Description Long |
| d. | Note Group ID |
| e. | Note Class ID |
| f. | Note Subclass ID |
| g. | Note and/or Note Attachments 1-N |

| | |
|---|---|
| 1. | Owner/Submitted By ID |
| 2. | Original Submission Date/Time |

| | |
|---|---|
| 2. | Modifications 1-N |

| | |
|---|---|
| a. | Owner/Submitted By ID |
| b. | Modification Submission Date |
| c. | Short Description |
| d. | Long Description |

| | |
|---|---|
| 1. | Owner/Submitted By ID |
| 2. | Original Submission Date/Time |
| 3. | Hyperlinks 1-N |
| 4. | Change Image 1-N |

| | |
|---|---|
| a. | Before Change |
| b. | After Change |

| 3. | Notes 1-N |
|---|---|
| Suppression Rules Database | |
| Hyperlink Database | |
| 1. | Hyperlink ID |
| 2. | Hyperlink |
| 3. | Description |
| 4. | Owner ID |
| 5. | Advertiser ID |
| 6. | Notes 1-N |
| User Database | |
| 1. | User ID |
| 2. | Name |
| 3. | Account Type |
| 4. | Description |
| 5. | Terms and Conditions ID |
| 6. | Text |
| 7. | Notes 1-N |
| Document Group Database | |
| 1. | Group ID |
| 2. | Description |
| 3. | Includes Sub-Groups/Sub-Class IDs 1 - n |
| 4. | Notes 1-N |
| Document Class | |
| 1. | Class ID |
| 2. | Description |
| 3. | Includes Sub-Class IDs 1-N |
| 4. | Notes 1-N |
| Document Sub Class | |
| 1. | Subclass ID |
| 2. | Description |
| 3. | Notes 1-N |
| Note Class | |
| 1. | Note Class ID |
| 2. | Description |
| 3. | Includes Sub-Class IDs 1-N |
| 4. | Notes 1-N |
| Note Subclass | |
| 1. | Note Subclass ID |
| 2. | Description |
| 3. | Notes 1-N |
| Nick Name Database | |
| 1. | Nick Name ID |
| 2. | Nick Name (Short Description) |
| 3. | Nick Name (Long Description) |
| 4. | patent or Document Number |
| 5. | Notes 1-N |
| Patent Application or Document ID Database | |
| 1. | Patent or Document ID # |
| 2. | Hyperlinks 1-N (e.g., Link to that patent on different websites) |
| 3. | Notes 1-N |
| Alert Event Rules Database | |
| 1. | Alert Event Rule ID |
| 2. | Alert Event Description |
| 3. | Alert Event Rules 1-N |

| | |
|---|---|
| a. | Event Condition |
| b. | Alert Recipient ID 1-N |

| | |
|---|---|
| 1. | Alert Method 1-N |

| | |
|---|---|
| c. | Alert Database ID 1-N |

| 4. | Notes 1-N |
|---|---|
| Alert Database | |
| 1. | Alert Database ID |
| 2. | Alert Contents, one or more of: |

| | |
|---|---|
| a. | Text |
| b. | Variable Data |
| c. | Executable |

| 3. | Notes 1-N |
|---|---|
| Alert Methods Database | |
| 1. | Alert Method ID |
| 2. | Method Type |
| 3. | Delivery Method (cell phone, pager, e-mail, PDA, database, |
| | executable, etc.) |
| 4. | Notes 1-N |
| Alert Recipient Database | |
| 1. | Alert Recipient ID (e.g., end user ID) |
| 2. | Description |
| 3. | Alert Method Preferences ID 1-N |
| 4. | Notes 1-N |
| Merchants Database | |
| 1. | Merchant ID |
| 2. | Name |
| 3. | Address |
| 4. | Shipping Information |
| 5. | Billing Information |
| 6. | Billing T&Cs ID |
| 7. | Classes of Trade IDs 1-N |
| 8. | Advertisement IDs 1-N |
| 9. | Notes 1-N |
| Thesaurus Database | |
| 1. | Word ID # |
| 2. | Entry Type (e.g., Synonym or Antonym) |
| 3. | Word ID # |
| 4. | Notes 1-N |
| Thesaurus Creation Rules Database | |
| 1. | Rule ID # |
| 2. | Description |
| 3. | Uses |
| 4. | Limitations |
| 5. | Rules 1-N |
| 6. | Notes 1-N |
| Word Class Database | |
| 1. | Class ID |
| 2. | Description |
| 3. | Notes 1-N |
| 4. | Includes Sub-classes 1-N |
| 5. | Notes 1-N |
| Word Subclass Database | |
| 1. | Sub-class ID |
| 2. | Description |
| 3. | Notes 1-N |
| 4. | Notes 1-N |
| Phrase Class Database | |
| 1. | Class id |
| 2. | Description |
| 3. | Includes Sub-classes 1-N |
| 4. | Notes 1-N |
| Phrase Subclass Database | |
| 1. | Sub-class ID |
| 2. | Description |
| 3. | Notes 1-N |
| Word Count Database | |
| 1. | Word ID |
| 2. | Word Count |
| 3. | Word Usage Tracking 1-N (e.g., hyperlinks) |
| 4. | Notes 1-N |
| Relevancy Percentage Database | |
| 1. | Relevancy ID # |
| 2. | Word or Document # |
| 3. | Related Word or Document # 1-N |
| 4. | Percentages 1-N |
| 5. | Notes 1-N |
| Map Database | |
| 1. | Map ID # |
| 2. | Description |
| 3. | Notes 1-N |
| 4. | Source Document ID # |

| | |
|---|---|
| a. | Source Words ID # 1-N |
| b. | Map references (sources) ID 1-N |
| c. | Map references (nodes) ID 1-N |
| d. | Map references (other) ID 1-N |
| e. | Related Document or Word ID # 1-N |

| | |
|---|---|
| 1. | Type ID (e.g., word or document, etc.) |
| 2. | Related Document or Word ID # 1-N |
| 3. | Related Document or Word ID Relevancy Score, %, or |
| | Rank |
| 4. | Map references (sources) ID 1-N |
| 5. | Map references (nodes) ID 1-N |
| 6. | Map references (other) ID 1-N |
| 7. | Notes 1-N |

| 5. | Notes 1-N |
|---|---|
| Thesaurus Notes Dtabase | |
| 1. | Thesaurus Note ID |
| 2. | Notes 1-N |
| IDS Database | |
| 1. | IDS ID # |
| 2. | IDS Document (text or document attachment) |
| 3. | Notes 1-N |

It will be appreciated that the various software and hardware components described above will be configured to perform a variety of functions and methods. Listed below are some exemplary methods that might be performed by the systems as described herein:

Create and Track Merchant Word Selections and Associated Advertisements
a. Receive a keyword from a merchant including a document class and subclass
b. Receive an advertisement to associate with the keyword
c. Receive an additional keyword from a merchant
d. Receive an indication that the advertisement was associated with the additional keyword
e. Store keywords and associated advertisements

Receive Document Creation Requests and Output Thesaurus
a. Receive a request to create a document including a document class and subclass
b. Determine words in document class and subclass
c. Associate words based on common advertisements associated with words
d. Generate and output word thesaurus based on class, subclass and associated advertisements

Optimize Thesaurus Based on Word Selections/Use
a. Receive an indication of use of a word in the thesaurus
b. Store thesaurus usage
c. Generate usage score for each word used
d. Generate list of relevant words organized/optimized based on scores
e. Output optimized list of words in subsequent Thesaurus sessions including scores

Update Online Thesaurus with Standard Thesaurus
a. Retrieve a standard thesaurus
b. Retrieve an online thesaurus generated based on advertisements associated with words
c. Enhance online thesaurus with standard thesaurus data
d. Store enhanced thesaurus for subsequent session use.

Update Standard Thesaurus with Online Thesaurus
a. Retrieve a standard thesaurus
b. Retrieve an online thesaurus generated based on advertisements associated with words
c. Enhance standard thesaurus with enhanced thesaurus data
d. Store enhanced thesaurus for subsequent session use.

Assign Relevancy % or Rank
a. Retrieve all word associations based on common advertisements
b. Score word associations based on number of common advertisements
c. Sort word associations based on number of common advertisements
d. Create and store word association list including sort and score

Create Document Map
a. Retrieve all advertisements associated with a document
b. Create and store document map of advertisements

Create Multiple Document Map
a. Retrieve a document map including words with associated advertisements
b. Create a document association based on map
c. Score documents based on document association
d. Store document scores

Add Notes to Thesaurus
a. Output thesaurus
b. Receive a request to add a note to a thesaurus entry
c. Receive note data
d. Store note data with thesaurus entry
e. Mark note data a “uncertified”

Certify Thesaurus
a. Receive certifier log in
b. Retrieve and output uncertified thesaurus data
c. Receive indication that thesaurus is certified
d. Mark thesaurus data as “certified”

Certify Thesaurus Notes
a. Receive certifier log in
b. Retrieve and output uncertified thesaurus note data
c. Receive indication that thesaurus note is certified
d. Mark note data as “certified”

Create Search Enhancement
a. Receive a common search word including class and subclass
b. Generate a list of associated words based on advertisement associations
c. Store associated words

Output Search Enhancement
a. Receive a search word
b. Determine if there are words associated with the search word
c. Output associated words in response to search word
d. Receive additional word selections from associated words
e. Modify search based on additional word selection

Create IDS Report
a. Receive Patent Data
b. Compare Patent Data to Document Maps
c. Compile Relevant Documents to Patent Data based on document maps
d. Generate IDS report of Relevant Documents

Determine Relevancy Score
a. Receive Patent Data
b. Compare Patent Data to Document Maps
c. Score Document Map Data to Patent Data based on scoring criteria
d. Store Relevancy Score with Document Maps for Patent Data

Use Advertisements to Create and or Enhance Thesaurus
a. Retrieve advertisements and associated words
b. Generate thesaurus based on advertisements and associated words
c. Store Thesaurus

Use Survey Questions to Improve Advertising Results
a. Receive a click on a hyperlinked word
b. Retrieve/Generate a survey in response to the click
c. Receive a response to the survey
d. Generate at least one advertisement in response to the click and the survey response
e. Receive a click on the advertisement.
f. Store click

Alter Hyperlinks Based on Criteria
a. Retrieve hyperlink click data
b. Score hyperlink click success rates
c. Modify hyperlink word selection based on click success rates (for example, stop linking an advertisement to a word, if no one clicks on the advertisement.)

Alert Users to Change in Status of Hyperlink
a. Determine that a hyperlink status has been changed (for example, the hyperlink to an advertisement has been disabled)
b. Generate a group of parties to notify
c. Notify parties that hyperlink has changed status

Create Maintain Databases
1. Initially Populate or create empty databases
2. Update Databases

Primary Application
1. Load Databases
2. Receive indication that one or more applications/routines should be executed periodically, upon request, continually or based upon other indicator(s)
3. Execute such one or more applications/routines as desired/necessary
4. Update Databases

Security Application
1. Load Database(s)
2. Determine if requested action and/or end user is permitted
3. If not, notify application and/or end user
4. If yes, permit requested step and/or loading of application or other authorized action(s)
5. Update Database(s)

End User Preferences Application
1. Load Databases
2. Present Preferences GUI if required
3. Receive End User Preferences/Feedback/Usage Tracking Information, including:
a. Filter Criteria or Rules
b. Sort Criteria or Rules
c. Relevancy Information
d. Weighting Factors, Criteria or Rules
e. Security Preferences
f. Feedback/Tracking Preferences
g. Notes
h. Usage habits/patterns
i. Display preferences

Opt In/Sign Up Application
1. Load Databases
2. Receiving Indication of new user sign up
3. Record any and all or available information regarding one or more patent applicant's, end users, examiners, attorneys and/or third parties
4. Update Databases

Create/Maintain Document Database
1. Load Databases
2. Determine Available or Participating Documents
3. Periodically Search all Available Documents
4. Create/update index for all found (or participating) documents
5. Receive indication of add/change/delete request(s)
6. If required, queue and review request(s)
7. If required, approved request(s)
8. Create/Update Document Databases
9. Update Databases

Create/Maintain Words Database
1. Load Databases
2. Search/Index all available documents
3. Create/update index for all words
4. Create/update/insert or maintain hyperlinks for all indexed words
5. Receive indication of add/change/delete request(s)
6. If required, queue and review request(s)
7. If required, approved request(s)
8. Create/Update Word Database
9. Update Databases

Create/Maintain Advertising Database
1. Load Databases
2. Receive request to add or maintain or delete one or more advertisements
3. Create/update index for all advertisements
4. If required, queue and review request(s)
5. If required, approved request(s)
6. Insert advertising hyperlink to word or document database and/or source material
7. Create/Update Advertising Databases
8. Update Databases

Advertisement Creation Application
1. Load Database(s)
2. Display advertising creation/modification GUI
3. Receive request to add/change/delete one or more advertisements
4. Receive advertisement hyperlink contents and associate with one or more words, synonyms, antonyms and/or figures and/or documents
5. Determine if such one or more words, synonyms, antonyms, figures and/or documents have pre-existing hyperlinks by current or third party end user or otherwise
6. If not, determine price to associate hyperlink as applicable
7. If one or more similar hyperlinks already exist, execute hyperlink bid pricing application
8. If approved and priced, insert or otherwise associate said hyperlink with said one or more words, synonyms, antonyms, figures and/or documents.
9. Update Database(s)

Hyperlink Pricing Program
1. Load Database(s)
2. Receive Pricing Request
3. Determine if more than one user wishes a hyperlink to the same or similar word(s), synonym(s), antonym(s), figure(s) and/or documents
4. Determine pricing and/or auction hyperlink, or, if applicable, position in list of two or more hyperlinks
5. Notify affected parties, e.g., via an alert
6. Receive indication from one or more users as to willingness to pay and price points
7. Continue process until pricing is determined
8. Receive authorizing for final pricing from affected parties, including end users
9. Update Database(s)

Advertisement Viewing/Use Application
1. Load Database(s)
2. Receive request to display or access advertisement, e.g., user clicks hyperlink or right clicks word
3. Determine if additional browser page or popup or other display method is to be used
4. Display Advertisement, e.g., load and display attached movie file
5. Determine if survey should be presented
6. Present Survey
7. Determine if secondary or different advertisement is to be displayed
8. Display Advertisement
9. Collect usage information, e.g., impressions for thesaurus relevancy improvement and billing purposes
10. Modify relevancy scores as determined by word, database and/or other application usage and/or using end user feedback
11. Update Database(s)

Word Definition/Synonym/Antonym/Figure/Document Lookup Tool
1. Load Database(s)
2. Receive request from drafting or third party display tool for word, definition, synonym, antonym, figure and/or document display (any one or any combination or all of the forgoing)
3. Determine Relevancy Information
4. Retrieve requested information, using relevancy information if applicable/available
5. Determine if additional browser page or popup or other display method is to be used (e.g., interstitial popup window)
6. Determine if application and/or end user has requested filter and/or sort and/or relevancy options
7. Display Requested Information (using filter, sort and/or relevancy information and/or filter criteria if applicable// available)
8. Determine if survey should be presented
9. If presented, gather survey results
10. Determine if advertisement or supplemental information should be displayed
11. Display advertisement or supplemental information as indicated
12. Determine if relevancy information should be modified based upon any one or more of such surveys, advertisements, end user usage or any combination of these
13. Update Database(s)

Document Submission/Filing Application
1. Load Database(s)
2. Receive request to submit document with words, synonyms, antonyms, figures and/or related documents to database, repository or processing agency, e.g., USPTO
3. Capture image of all relevant materials, including then current definitions, along with Time/Date stamp information
4. If desired, encrypt any or all output materials, e.g., patent application, definitions, words, synonyms, antonyms, figures and/or related documents and/or supporting materials to prevent or otherwise control subsequent access and/or modifications
5. Update Database(s)

Mapping Program
1. Load Databases
2. Receive indication that one or more words, synonyms, antonyms and/or documents have been added or changed or removed from one or more databases
3. Receive or Determine Relevancy Information
4. Determine mapping relationships among the forgoing
5. Monitor word, synonym, antonym, document and/or mapping usage
6. Receive feedback from end users and/or determine change in mapping relationships and/or relevancy
7. If desired or required, submit any such changes for review/approval
8. If approved, update mapping relationship data accordingly
9. Update Databases

End User Contest Application
1. Load Database(s)
2. Receive Indication that one or more end users and/or third parties, e.g., patent examiner, contests one or more word definitions, words, synonyms, antonyms, figures and/or other documents, maps and/or supporting materials
3. Determine relevancy/validity of the contest by any one or all of the following if desired/applicable
   a. Solicit other end user/third party votes/scores/ranking
   b. Use GA
   c. Submission to authorized end user or third party
   d. Preponderance of feedback
4. If contest is determined valid, accept requested changes
5. Otherwise Reject Requested Changes
6. Update Database(s)

Billing Program
a. Load Database(s)
b. Receive indication that billing activity has occurred
c. Determine affected parties, e.g., payer and payee
d. Determine billing rules, terms and conditions
e. Determine billing amounts due
f. Create Invoice and A/P or A/R notices/entries
g. Send Invoices and notices
h. Update Databases
i. Await Payment
j. Receive payment indication
k. Apply payments
l. Notify A/P or A/R systems/and/or affected parties
m. Determine if payments are timely/sufficient
n. If not, execute collections program
o. Update Database(s)

Collections Program
a. Receive indication payments are late and/or insufficient
b. Load Database(s)
c. If applicable, execute one or more of the following steps:
   1. Send late notice
   2. Send insufficient payment or funds notice
   3. Limit or prevent further use until payment terms are partially or fully satisfied, each according to billing terms and conditions and/or rules
   4. Collect funds due from primary and/or secondary credit cards on file.
   5. Notify Affected Parties
d. Update Database(s)

Create/Maintain Thesaurus
1. Load Databases
2. Create initial thesaurus by populating all known words
3. Periodically import known synonyms/antonyms
4. Receive add/change/delete and/or notes add/change/delete request
5. If required, queue and review request(s) and/or imported entries and/or notes
6. If required, approved request(s) and/or imported entries and/or notes
7. Add/Change/Delete synonym or antonym and/or entries and/or notes
8. If desired, add hyperlink in source or other databases to reference either or both the source word and/or the synonym or antonym and/or notes as applicable
9. Create/Update Thesaurus Database
10. Update Databases

Thesaurus Word Use Tracking
1. Load Databases
2. Receive indication of word or associated word use
3. Receive end user or other feedback/relevancy scores
4. Determine optimal relevancy scores based upon word use and/or feedback
5. Modify Relevancy Percentage
6. Update Databases

Document/Word Map Creation/Maintenance Program
1. Load Databases
2. Determine Word/Document Relevancy
3. Create relevancy map based upon relevancy scores and feedback and/or manual mapping activities
4. Create/Update Word/Document maps
5. Update Databases

User Interface Application
1. Load database(s)
2. Display graphical user interface for each application/feature as requested/desired
3. Receive Input from End Users
4. Execute functions as requested/required and/or load additional applications/GUIs
5. Update Databases

Create/Update IDS Database and Reporting
1. Load Databases
2. Import or receive one or more IDS submissions
3. If required, queue IDS for review/approval
4. If approved add to database, otherwise reject IDS
5. Periodically search, index and review IDS Database
6. Create IDS report
7. Distribute and/or submit report to interested/affected parties
8. Update Databases

Survey Program
1. Load Databases
2. Receive indicator that relevancy information should be updated
3. And/or periodically submit one or more survey questions to one or more end users
4. Determine questions based upon survey database rules and/or based upon prior effectiveness of one or more survey questions
5. Determine respondent or target end users
6. Submit questions to respondent(s)
7. Receive Results
8. Determine New Relevancy Scores
9. Update relevancy information and/or modify hyperlinks or advertisements based upon new or revised relevancy scores and/or other end user feedback
10. And/or use GA to determine relevancy scores and/or hyperlink and/or advertisements
11. Update Databases

Hyperlink Review Program
1. Load Databases
2. Determine Hyperlink Use/Effectiveness
3. Replace one or more underperforming hyperlinks with one or more replacement hyperlinks
4. Update Databases

Certification Program
1. Load Databases
2. Present Thesaurus, Notes, Advertisements and other Add/Changes/Delete requests and/or feedback to one or more authorized examiners/reviewers/peer review group(s)
3. Receive indication of reject or acceptance of such additions/changes/deletions, or other change requests and/or feedback.
4. If rejected, notify submitter(s)
5. If accepted, notify submitter(s) and update databases as applicable
6. Update Databases

Alerts Program
1. Load Database(s)
2. Determine if Alert Event has occurred
3. Determine Alert Contents based upon alert rules
4. Determine Alert Recipients and Contents and Delivery Method(s)
5. Send Alert(s)
6. Update Database(s)

Of course it will be appreciated that the systems methods described herein are provided for the purposes of example only and that none of the above systems methods should be interpreted as necessarily requiring any of the disclosed components or steps nor should they be interpreted as necessarily excluding any additional components or steps. Furthermore, it will be understood that while various embodiments are described, such embodiments should not be interpreted as being exclusive of the inclusion of other embodiments or parts of other embodiments.

The invention is described with reference to several embodiments. However, the invention is not limited to the embodiments disclosed, and those of ordinary skill in the art will recognize that the invention is readily applicable to many other diverse embodiments and applications as are reflected in the range of real world financial institutions, instruments and activities. Accordingly, the subject matter of the present disclosure includes all novel and nonobvious combinations and subcombinations of the various systems, methods configurations, embodiments, features, functions, and/or properties disclosed herein.

A reference to “another embodiment” in describing an embodiment does not necessarily imply that the referenced embodiment is mutually exclusive with another embodiment (e.g., an embodiment described before the referenced embodiment), unless expressly specified otherwise.

The terms “include”, “includes”, “including”, “comprising” and variations thereof mean “including but not limited to”, unless expressly specified otherwise.

The term “consisting of” and variations thereof includes “including and limited to”, unless expressly specified otherwise. The terms “a”, “an” and “the” mean “one or more”, unless expressly specified otherwise.

The term “plurality” means “two or more”, unless expressly specified otherwise.

The term “herein” means “in this patent application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The terms “such as”, “e.g.” and like terms means “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like. It does not imply certainty or absolute precision, and does not imply that mathematical processing, numerical methods or an algorithm process be used. Therefore “determining” can include estimating, predicting, guessing and the like.

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions.

A “processor” may include one or more microprocessors, central processing units (CPUs), computing devices, microcontrollers, digital signal processors, or like devices or any combination thereof. Thus a description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” includes any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, or a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the environment described herein.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each claim in a set of claims has a different scope. Therefore, for example, where a limitation is explicitly recited in a dependent claim, but not explicitly recited in any claim from which the dependent claim depends (directly or indirectly), that limitation is not to be read into any claim from which the dependent claim depends.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention which must be present in all embodiments.

Neither the Title (set forth at the beginning of the first page of this patent application) nor the Abstract (set forth at the end of this patent application) is to be taken as limiting in any way as the scope of the disclosed invention(s). An Abstract has been included in this application merely because an Abstract of not more than 150 words is required under 37 C.F.R. § 1.72(b).

The title of this patent application and headings of sections provided in this patent application are for convenience only, and are not to be taken as limiting the disclosure in any way.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a sequential order, such processes may be configured to work in different orders. In other words, any sequence or order of steps that may be explicitly described does not necessarily indicate a requirement that the steps be performed in that order. On the contrary, the steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

Unless expressly specified otherwise, an enumerated list of items (which may or may not be numbered) does not imply that any or all of the items are mutually exclusive. Therefore it is possible, but not necessarily true, that something can be considered to be, or fit the definition of, two or more of the items in an enumerated list. Also, an item in the enumerated list can be a subset (a specific type of) of another item in the enumerated list. For example, the enumerated list “a computer, a laptop, a PDA” does not imply that any or all of the three items of that list are mutually exclusive—e.g., an item can be both a laptop and a computer, and a “laptop” can be a subset of (a specific type of) a “computer”.

Likewise, unless expressly specified otherwise, an enumerated list of items (which may or may not be numbered) does not imply that any or all of the items are collectively exhaustive or otherwise comprehensive of any category. For example, the enumerated list “a computer, a laptop, a PDA” does not imply that any or all of the three items of that list are comprehensive of any category.

Further, an enumerated listing of items does not imply that the items are ordered in any manner according to the order in which they are enumerated.

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in this patent application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

The present disclosure provides, to one of ordinary skill in the art, an enabling description of several embodiments and/or inventions. Some of these embodiments and/or inventions may not be claimed in this patent application, but may nevertheless be claimed in one or more continuing applications that claim the benefit of priority of this patent application. Applicants intend to file additional applications to pursue patents for subject matter that has been disclosed and enabled but not claimed in this patent application.

What is claimed is:

1. A method comprising:
providing a database of documents including keywords;
receiving a request from an entity to hyperlink two keywords in the database to the same destination document; and
identifying the two keywords as being related to one another.

2. The method of claim 1 further comprising entering the keyword into a thesaurus database.

3. The method of claim 1 further comprising assigning a relationship between the two keywords in the thesaurus database.

4. The method of claim 3 further comprising assigning a relevancy rating to the relationship.

5. The method of claim 4 further comprising:
determining if the two keywords are identified as synonyms in a published thesaurus; and
modifying the relevancy rating based on the information from the published thesaurus.
